(19) United States
(12) Patent Application Publication
(10) Pub. No.: US 2014/0003539 A1
(43) Pub. Date: Jan. 2, 2014

(54) Signalling Information for Consecutive Coded Video Sequences that Have the Same Aspect Ratio but Different Picture Resolutions

(71) Applicant: Cisco Technology, Inc., San Jose, CA (US)

(72) Inventors: Arturo A. Rodriguez, Norcross, GA (US); Anil Kumar Katti, Atlanta, GA (US); Hsiang-Yeh Hwang, Duluth, GA (US)

(21) Appl. No.: 13/933,993

(22) Filed: Jul. 2, 2013

Related U.S. Application Data
(60) Provisional application No. 61/671,887, filed on Sep. 26, 2012.
(60) Provisional application No. 61/667,126, filed on Jul. 2, 2012.

(51) Int. Cl. H04N 7/26

(52) U.S. Cl. CPC H04N 19/00533
USPC 375/240.25

(57) ABSTRACT

In one embodiment, receiving at a video stream receive-and-process (VSRP) device auxiliary information corresponding to a video stream, the auxiliary information corresponding to a spatial span; receiving at the VSRP device the video stream comprising a first portion of compressed pictures having a first picture resolution format and a second portion having a second picture resolution format during transmission over a given channel, wherein the first compressed picture of the second portion of compressed pictures is the first compressed picture in the video stream after the last compressed picture of the first portion of compressed pictures; and decoding the first and second portions of the video stream, and scaling the decoded picture data from the second video stream according to the received auxiliary information and outputting the first and second decoded portions of the video stream, such that a spatial span of decoded picture data from the second video stream is same as that of the first video stream.

### TECHNICAL FIELD

This disclosure relates in general to processing of video signals, and more particularly, to processing of video signals in compressed form

### BACKGROUND

In systems that provide video programs such as subscriber television networks, the internet or digital video players, a device capable of providing video services or video playback includes hardware and software necessary to input and process a digital video signal to provide digital video playback to the end user with various levels of usability and/or functionality. The device includes the ability to receive or input the digital video signal in a compressed format, wherein such compression may be in accordance with a video coding specification, decompress the received or input digital video signal, and output the decompressed video signal. A digital video signal in compressed form is referred to herein as a bitstream that contains successive coded video sequences. A number of video applications require support for bitstreams in which the picture resolution may change from one coded video sequence to the next, while maintaining constant the 2D size of the output pictures of the successive coded video sequences.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates an example environment in which video processing (VP) systems and methods may be implemented.

FIG. 2A is a block diagram of an example embodiment of a video stream receive-and-process (VSRP) device comprising an embodiment of a VP system.

FIG. 2B is a block diagram of an example embodiment of display and output logic of a VSRP device.

FIG. 3 is a flow diagram that illustrates one example VP method embodiment to process video based on auxiliary information.

### DESCRIPTION OF EXAMPLE EMBODIMENTS

### Overview

In one method embodiment, a receive-and-process (VSRP) device may receive a bitstream of successive coded pictures and auxiliary information that respectively corresponds to each consecutive portion of the successive coded pictures of the bitstream. First auxiliary information corresponding to a first portion of the bitstream corresponds to a first implied spatial span for the successive coded pictures in the first portion. Second auxiliary information corresponding to a second portion of the bitstream corresponds to a second implied spatial span for the successive coded pictures in the second portion. A first coded picture of the second portion of successive coded pictures of the bitstream is the first coded picture in the bitstream after a last coded picture of the first portion of successive coded pictures of the bitstream. The VSRP decodes the received successive coded pictures of the first portion and outputs the decoded pictures in accordance with the first implied spatial span corresponding to the first auxiliary information. The VSRP decodes the received successive coded pictures of the second portion and outputs the decoded pictures in accordance with the second implied spatial span corresponding to the second auxiliary information, such that the first and second implied spatial span are equal, and wherein the respective picture resolution of the decoded pictures corresponding to the first portion of the bitstream is different to the respective picture resolution of the decoded pictures corresponding to the second portion of the bitstream, and wherein the respective sample aspect ratio (SAR) of the decoded pictures corresponding to the first portion of the bitstream is equal to the respective SAR of the decoded pictures corresponding to the second portion of the bitstream

### Example Embodiments

Disclosed herein are various example embodiments of video processing (VP) systems and methods (collectively, referred to herein also as a VP system or VP systems) that convey and process auxiliary information delivered in, corresponding to, or associated with, a bitstream. In one embodiment, the auxiliary information signals to video stream receive-and-process (VSRP) device the picture resolution, SAR, and a sample scale factor (SSF) for a respectively corresponding coded video sequence (CVS). More specifically the picture resolution corresponds to a number of horizontal luma samples and a number of vertical luma samples in each of the successive pictures of the respectively corresponding CVS, and the SAR corresponds to the “sample width” and sample height” that corresponds to the shape of each of the luma samples, or luma pixels, in each of the successive pictures of the respectively corresponding CVS. The picture resolution, SAR, and SSF remain constant throughout all the successive pictures of a CVS. The applicable picture resolution and SAR that correspond to other components of the picture, such as chroma samples, is according to the derivation corresponding to the respective components. For example, for 4:2:0 chroma sampling, each of the two chroma components of each picture of the CVS will have half the number of horizontal samples and half the number of vertical samples but the same SAR as the luma samples.

In one embodiment, the SAR and SSF are provided in the auxiliary information separately. In an alternate embodiment, the SSF is not provided separately but implied via the SAR provided in the auxiliary information. The sample width and height corresponding to a SAR are both multiplied to imply a SSF that a VSRP can derive.

When SAF and SSF are provided separately in the auxiliary information, if SAR corresponds to “sample width” and “sample height,” the width of the implied spatial span of the pictures of a CVS corresponds to: the number of horizontal luma samples multiplied by the SSF and by the sample width and divided by the sample height, and the height of the implied spatial span of the pictures of the CVS correspond to the number of vertical luma samples multiplied by the SSF.

When SAF and SSF are provided separately in the auxiliary information, if the SSF is equal to 1 and the SAR corresponds to “sample width” and “sample height,” the width of the implied spatial span of the pictures of a CVS corresponds to: the number of horizontal luma samples multiplied by the sample width and divided by the sample height, and the height of the implied spatial span of the pictures of the CVS correspond to the number of vertical luma samples.

When SAF and SSF are provided separately in the auxiliary information, if the SAR corresponds to a sample width equal to the sample height, the width of the implied spatial span of the pictures of a CVS corresponds to: the number of horizontal luma samples multiplied by the SSF, and the height of the implied spatial span of the pictures of the CVS correspond to the number of vertical luma samples multiplied by the SSF.

The auxiliary information serves as a basis for the VSRP device to scale the decoded picture version of the coded pictures of a CVS for output or display according the implied spatial span. The auxiliary information further serves to output or display pictures corresponding to a constant implied spatial span when the picture resolution changes from a first to a subsequent or second CVS of a bitstream but the SAR does not by specifically providing a different SSF that corresponds to the second CVS.

The auxiliary information serves to signal a different SSF when the picture resolution changes but the SAR does not in the second of two consecutive CVSes. That is, the there is a picture resolution change not an SAR change from the last coded picture of a first CVS of the bitstream to the first coded picture in a second CVS that immediately follows the first CVS.

In some embodiments, the auxiliary information may be provided as a flag indicating a change in the auxiliary information of two successive coded video sequences (CVSes) being received at the VSRP device. As an example, the flag may be included based on a main picture size in terms of being used for the majority of the CVSes or span of time in the bitstream (e.g., the principal picture resolution of a television service or video program). In some embodiments, the auxiliary information includes a main picture resolution among plural anticipated picture resolutions of a video service or video program. Alternate picture resolutions may be inserted or provided in designated or signaled demarcated segments of the bitstream of a television service or broadcast network feed. For instance, an advertisement segment may be inserted at a network device, such as a splicing device that replaces the designated or demarcated segments with local or regional commercials.

Variations of picture resolutions in the bitstream may occur (one or more times) during a transmitted television service, such as during an interval of a single broadcast program, such as when local commercials are provided in, or spliced into, one or more portions of the bitstream.

A number of video applications require keeping constant the 2D size and aspect ratio of the spatial span implied by the output pictures of successive CVSes in the bitstream. As an example, when an advertisement is inserted in a broadcast applications, where the picture resolution changes, the spatial span of the output pictures displayed from the advertisement is expected to be same as the spatial span of the output pictures from the broadcast application. Moreover, a physical clock driving the output stage of a receiver or video players, or VSRP must not change from one to the next CVS to avoid disruptions in the physical video output signal and to minimize the number of blank output pictures.

In one embodiment, auxiliary information may be provided with the bitstream, to enable the VSRP device to detect the changes in the auxiliary information corresponding to a subsequent CVS. As an example, when both, the picture resolution and the SAR change in the second of two consecutive CVSes in the bitstream, the auxiliary information may be provided in form of aspect_ratio_idc value, signalling the VSRP device to scaling devices according to the auxiliary information of the corresponding CVS. The aspect_ratio_idc value may be chosen such that the 2D size and aspect ratio of the spatial span implied by the output pictures of the second CVS equals the implied spatial span corresponding to the first of the two consecutive CVSes. The signalled respective aspect_ratio_idc values corresponding to the two consecutive CVSes may be different to indicate a difference in the SARs of the two CVSes. However, in some cases, the picture resolution may change in the second of the two consecutive CVSes but the SAR remains the same. In such case, both horizontal resolution and vertical resolution of output picture change. For instance, a bitstream may have consecutive CVSes that change picture resolutions between 1280×720 and 1920×1080, or vice versa, but the SAR remains square. The auxiliary information, in such case, may signal that the output pictures of some CVSes with an aspect_ratio_idc value that may correspond to square pixels that have a sample scale factor not equal to one. As an example, for a bitstream where the 1920×1080 picture resolution is expected to be the main (or dominant) picture resolution, all the CVSes with 1920×1080 resolution may have an aspect_ratio_idc values corresponding to square pixels and thus a SAR with equal sample width and sample height. That is, the aspect_ratio_idc value may signal a SAR equal to 1:1 which is a square pixel. However, the CVSes with 1280×720 resolution may have an aspect_ratio_idc value corresponding to square pixels and a sample scale factor corresponding to a sample width equal to three and a sample height equal to two (i.e., SAR=3:2) so that the implied spatial span by the output pictures remains constant at 1920×1080 throughout the successive CVSes. For these CVSes, the signalled aspect_ratio_idc value implies a “1.5:1.5” square pixel, or a square sample with a SSF equal to 1.5.

For a bitstream of a video program where the 1280×720 picture resolution is the dominant or main picture resolution, the CVSes with 1920×1080 resolution may be signalled with an aspect_ratio_idc value that corresponds to square pixels and a sample scale factor corresponding to a sample width equal to two and sample height equal to three (i.e., 2:3). In this case, CVSes with 1280×720 resolution may have a signalled aspect_ratio_idc value corresponding to square pixels and a sample scale factor of one. The implied spatial span by the output pictures of all the CVSes is 1280×720.

In some embodiments, a bitstream may contain CVSes with quarter-sized pictures with the same SAR as the full-size pictures in other CVSes. For example, a bitstream may contain a 1920×1080 CVS followed by a 960×540 CVS, both with square samples. In such case, the signalled aspect_ratio_idc value of the second CVS may correspond to square pixels with a SSF equal to 2 (i.e., 2:2 square samples) to imply a 1920×1080 spatial span for the output pictures.

In some embodiments, the VSRP device may be configured to use the aspect_ratio_idc value received in the auxiliary information corresponding to a CVS for determining an implied SSF. As an example, the VSRP device may be preconfigured to interpret the aspect_ratio_idc value to correspond to a SAR and a SSF. In another example, the VSRP device may be configured to perform a lookup operation in a table to determine the SSF renewed from the auxiliary data. The portion of the table corresponds to aspect_ratio_idc values with implied SSFs may be provided with the bitstream in one embodiment. In an alternate embodiment, VSRP device knows a priori the SSF table according to a specification that provides the syntax and semantics of the auxiliary information. As an example of the portion of the table is provided below:

TABLE 1
Semantics of sample aspect ratio indicator

| | Interpretation of aspect_ratio_idc |
|---|---|
| aspect_ratio_idc | (Informative - Examples of Use) |
| 17 | 1.5:1.5 sample aspect ratio; square sample with a |
| | sample width equal to 1.5 and a sample height |
| | equal to 1.5 (1280×720 16:9 frame output |
| | as 1920×1080) |
| 18 | 0.667:0.667 sample aspect ratio; square sample |
| | with a sample width equal to 0.667 and a sample |
| | height equal to 0.667 (1920×1080 16:9 frame output |
| | as 1280×720) |
| 19 | 2:2 sample aspect ratio; square sample with a sample |
| | width equal to 2 and a sample height equal to 2 |
| | (960×540 16:9 frame output as 1920×1080) |
| 20 | 0.5:0.5 sample aspect ratio; square sample with a |
| | sample width equal to 0.5 and a sample height |
| | equal to 0.5 (1920×1080 16:9 frame output |
| | as 960×540) |

In one embodiment, a bitstream may be entered at a CVS that does not contain a dominant picture resolution (i.e., the dominant resolution being the most common picture resolution expected in the bitstream) but that has the same SAR as that of the CVS that contains the dominant picture resolution. In such scenario, a sample scale factor not equal to one is signaled to set the implied spatial span corresponding to the dominant picture resolution. The sample scale factor may be signalled via an aspect_ratio_idc value that implies the required sample scale factor or separately via the alternate methods described herein.

In some embodiment, the aspect_ratio_idc may signal any predefined aspect_ratio_idc value and the sample scale factor may be signalled separately. As an example, a sample_scale_factor_flag equal to one may specify the presence of a sample scale factor not equal to one. When the sample_scale_factor_flag equals one, it may specify presence of a sample_scale_factor_index. The sample_scale_factor_index may immediately follow the sample_scale_factor_flag (for instance, as a 2-bit, 3-bit, or 4-bit unsigned integer field) such as in a video usability information (VUI) portion of the Sequence Parameter Set (SPS) of the corresponding CVS. The sample_scale_factor_index may provide a value that may serve as an index to an entry in a table of sample scale factors, such as Table 2 given below. The sample scale factor table may contain predetermined sample scale factors deemed relevant to commercial insertion applications, such as 0.6667, 1.5, 2.0, and 0.5. Some entries of the table may be reserved values for future use, such as to signal additional sample scale factors that are not equal to one.

In an alternate embodiment, the auxiliary information in the bitstream may provide the SSF via the sample_scale_factor_flag. The presence of sample_scale_factor_flag in the bitstream may provide an indication to the VSRP to derive the implied spatial span of the second CVS of the bitstream and process its output pictures accordingly. As an example, sample_scale_factor_flag equal to 1(one) may specify that the sample_scale_factor_index is present, and sample_scale_factor_flag equal to 0 (zero) may specify that the sample_scale_factor_index is not present. In this alternate embodiment, an entry of the table of sample scale factors may correspond to a sample scale factor equal to 1.0. Hence, when sample_scale_factor_flag is equal to 1, it may or may not provide a sample scale factor that is not equal to one.

TABLE 2
Sample Scale Factor Table

| sample_scale_factor_index | sample_scale_factor |
|---|---|
| 0 | 1.5 (3/2) |
| 1 | 0.667 (2/3) |
| 2 | 2.0 |
| 3 | 0.5 |
| 4-7 | Reserved |

TABLE 3
Relevant VUI parameters syntax

| vui_parameters( ) { | Descriptor |
|---|---|
| aspect_ratio_info_present_flag | u(1) |
| if( aspect_ratio_info_present_flag ) { | |
| aspect_ratio_idc | u(8) |
| if( aspect_ratio_idc = = Extended_SAR ) { | |
| sar_width | u(16) |
| sar_height | u(16) |
| } | |
| sample_scale_factor_flag | u(1) |
| if(sample_scale_factor_flag) | |
| sample_scale_factor_index | u(3) |
| } | |
| } | |
| .... | |

In an alternate embodiment, the sample_scale_factor_flag in VUI parameters signals the presence of a sample scale factor that is not equal to one and the VSRP device may derive the SSF.

In one embodiment, to maintain constant the 2D size and aspect ratio of the spatial span implied by the output pictures of two consecutive CVSes in a bitstream, CVSa and CVSb that have square SARs but different SSFs corresponding to (sar_x_a: sar_y_a) and (sar_x_b: sar_y_b), and respective picture resolutions: (width_x_a: height_y_a) and (width_x_b: height_y_b), the following equations is maintained throughout the successive CVSes for the implied spatial span:

(sar_{—}x_{—}a)*(width_{—}x_{—}a)=(sar_{—}x_{—}b)*(width_{—}x_{—}b) (1)

(sar_{—}y_{—}a)*(height_{—}y_{—}a)=(sar_{—}y_{—}b)*(height_{—}y_{—}b) (2)

The equation (1) and the equation (2) may fulfill the requirement of maintaining an implied spatial span that is constant. The equation (1) and the equation (2) also fulfill the requirement when the SARS in the two respective auxiliary information corresponding to two consecutive CVSes are provided with two respective aspect_ratio_idcs and at least one of the two corresponds to a SAR that implies a SSF not equal to one, such as when:

sar_{—}x_{—}a does not equal sar_{—}x_{—}b, and sar_{—}y_{—}a does not equal sar_{—}y_{—}b, but: (sar_{—}x_{—}a/sar_{—}y_{—}a)=(sar_{—}x_{—}b/sar_{—}y_{—}b) (3)

In some embodiments, the presence of the sample scale factor (e.g., scale_factor_b) is signalled by a flag in the VUI of the SPS corresponding to the CVS (e.g., CVSb) and the sample scale factor is also provided in the VUI of the SPS corresponding to that CVS. Alternatively, the sample scale factor may be provided by an SEI (supplemental enhancement information) message that corresponds to the CVS. In one embodiment the sample scale factor may be provided via a value that represents an index to a table of sample scale factors.

In another embodiment, the sample_scale_factor_flag in VUI parameters (in the SPS corresponding to the CVS) may signal the presence of a sample scale factor that is not equal to one, and sar_x and sar_y are provided explicitly via an aspect_ratio_idc value that signals the presence of two explicit values to be read, the read values respectively corresponding to sar_x and sar_y. Both, the sar_x and sar_y values are equally scaled to imply the sample scale factor that is not equal to one.

In yet another embodiment, the sample scale factor may be provided in the VUI of the SPS corresponding to the CVS by providing an aspect_ratio_idc value that signals the presence of two explicit values to be read, the read values respectively corresponding to sar_x and sar_y. Both, the sar_x and sar_y values are equally scaled to imply the sample scale factor that is not equal to one.

In one embodiment, for infrequent or long times between picture resolution transitions, the periodicity of auxiliary information may differ (e.g., longer). For example, for single or dual scheduled daily transition of picture formats in a video service, the auxiliary information may be replicated and provided or signaled in the video service prior to the respective occurrence of the transition of picture formats in the bitstream. For instance, the auxiliary information is provided periodically at the transport or higher layer than the coded video layer.

These and/or other features and embodiments are described hereinafter in the context of an example subscriber television system environment, with the understanding that other multi-media (e.g., video, graphics, audio, and/or data) environments, including Internet Protocol Television (IPTV) network environments, cellular phone environments, and/or hybrids of these and/or other networks, may also benefit from certain embodiments of the VP systems and methods and hence are contemplated to be within the scope of the disclosure. It should be understood by one having ordinary skill in the art that, though specifics for one or more embodiments are disclosed herein, such specifics as described are not necessarily part of every embodiment.

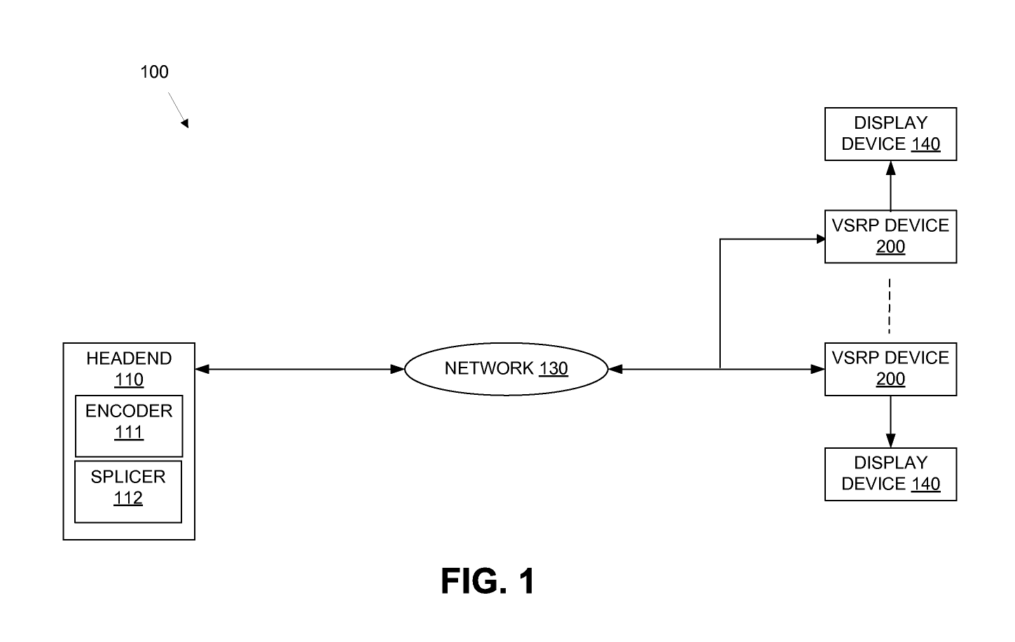

FIG. 1 is a high-level block diagram depicting an example environment in which one or more embodiments of a VP system are implemented. In particular, FIG. 1 is a block diagram that depicts an example subscriber television system (STS) 100. In this example, the STS 100 includes a headend 110 and one or more video stream receive-and-process (VSRP) devices 200. In some embodiments, one of the VSRP devices 200 may not be equipped with functionality to process auxiliary information that conveys picture resolution information, SAR, and SSF, such as auxiliary information corresponding to the implied spatial span of a main picture resolutions, or one of the plural anticipated picture formats, and/or the intended output picture resolution. The VSRP devices 200 and the headend 110 are coupled via a network 130. The headend 110 and the VSRP devices 200 cooperate to provide a user with television services, including, for example, broadcast television programming, interactive program guide (IPG) services, video-on-demand (VOD), and pay-per-view, as well as other digital services such as music, Internet access, commerce (e.g., home-shopping), voice-over-IP (VOIP), and/or other telephone or data services.

The VSRP device 200 is typically situated at a user's residence or place of business and may be a stand-alone unit or integrated into another device such as, for example, the display device 140, a personal computer, personal digital assistant (PDA), mobile phone, among other devices. In other words, the VSRP device 200 (also referred to herein as a digital receiver or processing device or digital home communications terminal (DHCT)) may comprise one of many devices or a combination of devices, such as a set-top box, television with communication capabilities, cellular phone, personal digital assistant (PDA), or other computer or computer-based device or system, such as a laptop, personal computer, DVD/CD recorder, among others. As set forth above, the VSRP device 200 may be coupled to the display device 140 (e.g., computer monitor, television set, etc.), or in some embodiments, may comprise an integrated display (with or without an integrated audio component).

The VSRP device 200 receives signals (video, audio and/or other data) including, for example, digital video signals in a compressed representation of a digitized video signal such as, for example, CVS modulated on a carrier signal, and/or analog information modulated on a carrier signal, among others, from the headend 110 through the network 130, and provides reverse information to the headend 110 through the network 130. As explained further below, the VSRP device 200 comprises, among other components, a video decoder and a horizontal scalar and a vertical scalar that in one embodiment is reconfigured upon acquiring or starting a video source and such reconfiguration in accordance to auxiliary information in the bitstream that corresponds to an implied spatial span for output pictures, such as when changing a channel or starting a VOD session, respectively. The VSRP device 200 further reconfiguring the size of pictures upon receiving in the bitstream a change in picture resolution that is signaled in the auxiliary information corresponds to the second of the two consecutive CVSes of the bitstream in accordance with received auxiliary information corresponding to the second CVS.

The television services are presented via respective display devices 140, each which typically comprises a television set. However, the display devices 140 may also be any other device capable of displaying the sequence of pictures of a video signal including, for example, a computer monitor, a mobile phone, game device, etc. In one implementation, the display device 140 is configured with an audio component (e.g., speakers), whereas in some implementations, audio functionality may be provided by a device that is separate yet communicatively coupled to the display device 140 and/or VSRP device 200. Although shown communicating with a display device 140, the VSRP device 200 may communicate with other devices that receive, store, and/or process bitstreams from the VSRP device 200, or that provide or transmit bitstreams or uncompressed video signals to the VSRP device 200.

The network 130 may comprise a single network, or a combination of networks (e.g., local and/or wide area networks). Further, the communications medium of the network 130 may comprise a wired connection or wireless connection (e.g., satellite, terrestrial, wireless LAN, etc.), or a combination of both. In the case of wired implementations, the network 130 may comprise a hybrid-fiber coaxial (HFC) medium, coaxial, optical, twisted pair, etc. Other networks are contemplated to be within the scope of the disclosure, including networks that use packets incorporated with and/or are compliant to MPEG-2 transport or other transport layers or protocols.

The headend 110 may include one or more server devices (not shown) for providing video, audio, and other types of media or data to client devices such as, for example, the VSRP device 200. The headend 110 may receive content from sources external to the headend 110 or STS 100 via a wired and/or wireless connection (e.g., satellite or terrestrial network), such as from content providers, and in some embodiments, may receive package-selected national or regional content with local programming (e.g., including local advertising) for delivery to subscribers. The headend 110 also includes one or more encoders (encoding devices or compression engines) 111 (one shown) and one or more video processing devices embodied as one or more splicers 112 (one shown) coupled to the encoder 111. In some embodiments, the encoder 111 and splicer 112 may be co-located in the same device and/or in the same locale (e.g., both in the headend 110 or elsewhere), while in some embodiments, the encoder 111 and splicer 112 may be distributed among different locations within the STS 100. For instance, though shown residing at the headend 110, the encoder 111 and/or splicer 112 may reside in some embodiments at other locations such as a hub or node. The encoder 111 and splicer 112 are coupled with suitable signaling or provisioned to respond to signaling for portions of a video service where commercials are to be inserted.

The encoder 111 provides a compressed bitstream (e.g., in a transport stream) to the splicer 112 while both receive signals or cues that pertain to splicing or digital program insertion. In some embodiments, the encoder 111 does not receive these signals or cues. In one embodiment, the encoder 111 and/or splicer 112 are further configured to provide auxiliary information corresponding to respective CVSes in the bitstream to convey to the VSRP devices 200 instructions corresponding to implied spatial span of output pictures as previously described.

The splicer 112 splices one or more CVSes into designated portions of the bitstream provided by the encoder 111 according to one or more suitable splice points, and/or in some embodiments, replaces one or more of the CVSes provided by the encoder 111 with other CVSes. Further, the splicer 112 may pass the auxiliary information provided by the encoder 111, with or without modification, to the VSRP device 200, or the encoder 111 may provide the auxiliary information directly (bypassing the splicer 112) to the VSRP device 200. The bitstream output of the splicer 112 includes a first CVS having a first picture resolution that was provided by the encoder 111, followed by a second CVS having a second picture resolution that is provided by the splicer 112. In one embodiment, the second picture resolution provided by the splicer 112 for a first splice operation equals the first picture resolution and for a second splice operation, the splicer 112 provides a third picture resolution for a third CVS in the bitstream that is different than the first picture resolution provided by the encoder 111 in the designated spliced portion of the bitstream corresponding to the network feed.

The auxiliary information in the various embodiments described above may be replicated or embodied such as a descriptor in a table (e.g., PMT), or in the transport layer. This feature enables the VSRP device 200 to set-up decoding logic and a display pipeline without interrogating the video coding layer to obtain the necessary information, hence shortening channel change time.

The STS 100 may comprise an IPTV network, a cable television network, a satellite television network, or a combination of two or more of these networks or other networks. Further, network PVR and switched digital video are also considered within the scope of the disclosure. Although described in the context of video processing, it should be understood that certain embodiments of the VP systems described herein also include functionality for the processing of other media content such as compressed audio streams.

The STS 100 comprises additional components and/or facilities not shown, as should be understood by one having ordinary skill in the art. For instance, the STS 100 may comprise one or more additional servers (Internet Service Provider (ISP) facility servers, private servers, on-demand servers, channel change servers, multi-media messaging servers, program guide servers), modulators (e.g., QAM, QPSK, etc.), routers, bridges, gateways, multiplexers, transmitters, and/or switches (e.g., at the network edge, among other locations) that process and deliver and/or forward (e.g., route) various digital services to subscribers.

In one embodiment, the VP system comprises the headend 110 and one or more of the VSRP devices 200. In some embodiments, the VP system comprises portions of each of these components, or in some embodiments, one of these components or a subset thereof. In some embodiments, one or more additional components described above yet not shown in FIG. 1 may be incorporated in a VP system, as should be understood by one having ordinary skill in the art in the context of the present disclosure.

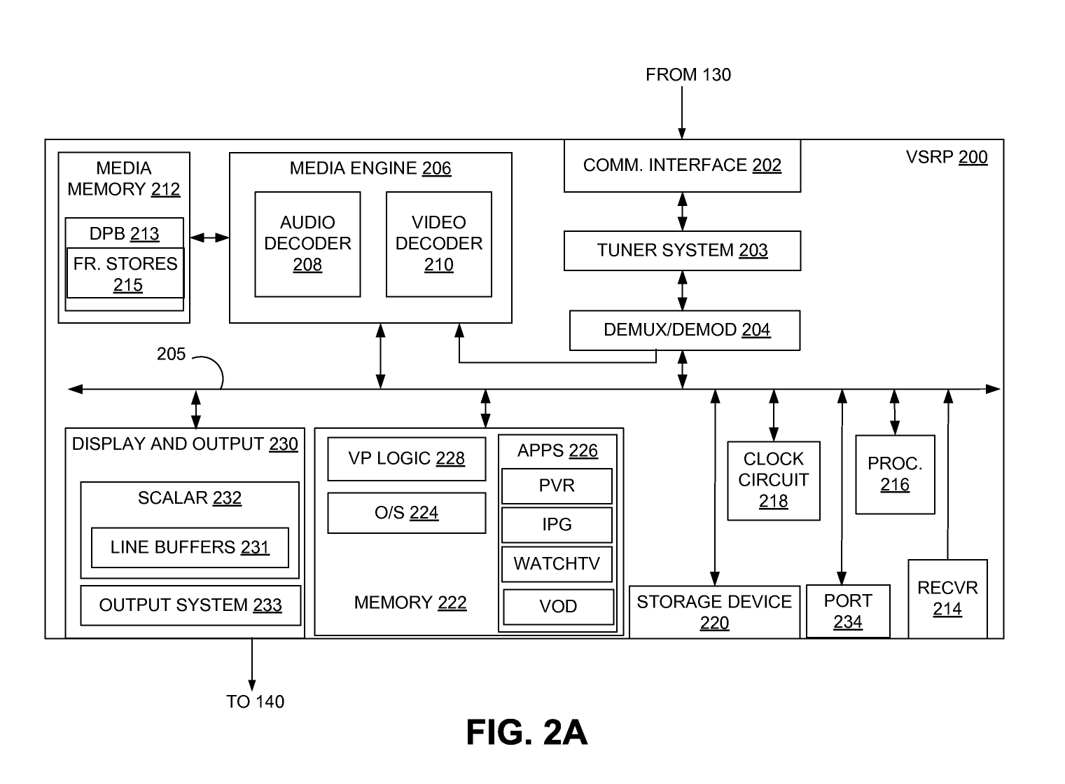

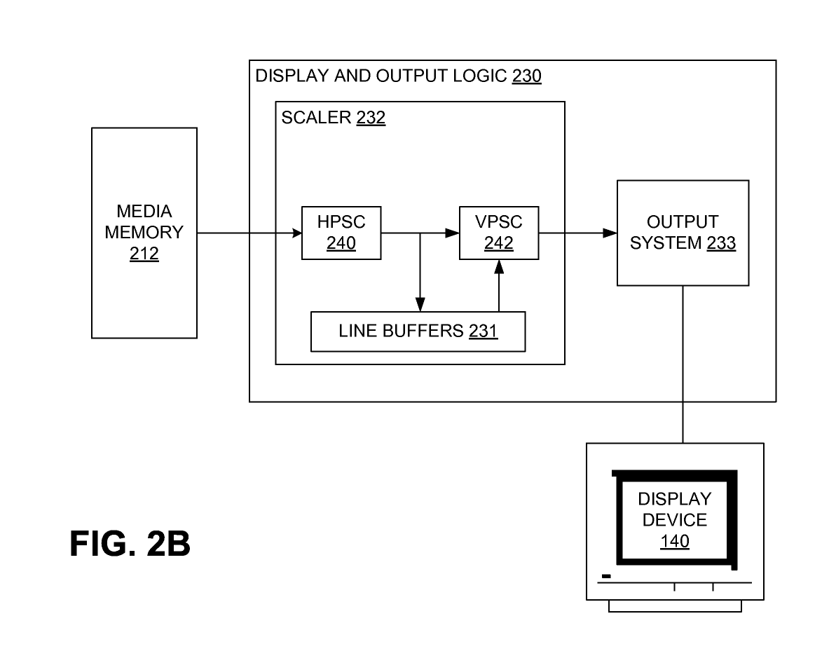

FIG. 2A is an example embodiment of select components of a VSRP device 200. It should be understood by one having ordinary skill in the art that the VSRP device 200 shown in FIG. 2A is merely illustrative, and should not be construed as implying any limitations upon the scope of the disclosure. In one embodiment, a VP system may comprise all components shown in, or described in association with, the VSRP device 200 of FIG. 2A. In some embodiments, a VP system may comprise fewer components, such as those limited to facilitating and implementing the decoding of compressed bitstreams and/or output pictures corresponding to decoded versions of coded pictures in the bitstream. In some embodiments, functionality of the VP system may be distributed among the VSRP device 200 and one or more additional devices as mentioned above.

The VSRP device 200 includes a communication interface 202 (e.g., depending on the implementation, suitable for coupling to the Internet, a coaxial cable network, an HFC network, satellite network, terrestrial network, cellular network, etc.) coupled in one embodiment to a tuner system 203. The tuner system 203 includes one or more tuners for receiving downloaded (or transmitted) media content. The tuner system 203 can select from a plurality of transmission signals provided by the STS 100 (FIG. 1). The tuner system 203 enables the VSRP device 200 to tune to downstream media and data transmissions, thereby allowing a user to receive digital media content via the STS 100. The tuner system 203 includes, in one implementation, an out-of-band tuner for bi-directional data communication and one or more tuners (in-band) for receiving television signals. In some embodiments (e.g., IPTV-configured VSRP devices), the tuner system may be omitted.

The tuner system 203 is coupled to a demultiplexing/demodulation system 204 (herein, simply demux 204 for brevity). The demux 204 may include MPEG-2 transport demultiplexing capabilities. When tuned to carrier frequencies carrying a digital transmission signal, the demux 204 enables the separation of packets of data, corresponding to the desired CVS, for further processing. Concurrently, the demux 204 precludes further processing of packets in the multiplexed transport stream that are irrelevant or not desired, such as packets of data corresponding to other bitstreams. Parsing capabilities of the demux 204 allow for the ingesting by the VSRP device 200 of program associated information carried in the bitstream. The demux 204 is configured to identify and extract information in the bitstream to facilitate the identification, extraction, and processing of the coded pictures. Such information includes Program Specific Information (PSI) (e.g., Program Map Table (PMT), Program Association Table (PAT), etc.) and parameters or syntactic elements (e.g., Program Clock Reference (PCR), time stamp information, payload_unit_start_indicator, etc.) of the transport stream (including packetized elementary stream (PES) packet information).

In one embodiment, additional information extracted by the demux 204 includes the aforementioned auxiliary information pertaining to the CVSes of the bitstream that assists the decoding logic (in cooperation with the processor 216 executing code of the VP logic 228 to interpret the extracted auxiliary information) to derive the implied spatial span corresponding to the pictures to be output, and in some embodiments, further assists display and output logic 230 (in cooperation with the processor 216 executing code of the VP logic 228) in processing reconstructed pictures for display and/or output.

The demux 204 is coupled to a bus 205 and to a media engine 206. The media engine 206 comprises, in one embodiment, decoding logic comprising one or more of a respective audio decoder 208 and video decoder 210. The media engine 206 is further coupled to the bus 205 and to media memory 212, the latter which, in one embodiment, comprises one or more respective buffers for temporarily storing compressed (compressed picture buffer or bit buffer, not shown) and/or reconstructed pictures (decoded picture buffer or DPB 213). In some embodiments, one or more of the buffers of the media memory 212 may reside in other memory (e.g., memory 222, explained below) or components.

The VSRP device 200 further comprises additional components coupled to the bus 205 (though shown as a single bus, one or more buses are contemplated to be within the scope of the embodiments). For instance, the VSRP device 200 further comprises a receiver 214 (e.g., infrared (IR), radio frequency (RF), etc.) configured to receive user input (e.g., via direct-physical or wireless connection via a keyboard, remote control, voice activation, etc.) to convey a user's request or command (e.g., for program selection, stream manipulation such as fast forward, rewind, pause, channel change, one or more processors (one shown) 216 for controlling operations of the VSRP device 200, and a clock circuit 218 comprising phase and/or frequency locked-loop circuitry to lock into a system time clock (STC) from a program clock reference, or PCR, received in the bitstream to facilitate decoding and output operations. Although described in the context of hardware circuitry, some embodiments of the clock circuit 218 may be configured as software (e.g., virtual clocks) or a combination of hardware and software. Further, in some embodiments, the clock circuit 218 is programmable.

The VSRP device 200 may further comprise a storage device 220 (and associated control logic as well as one or more drivers in memory 222) to temporarily store buffered media content and/or more permanently store recorded media content. The storage device 220 may be coupled to the bus 205 via an appropriate interface (not shown), as should be understood by one having ordinary skill in the art.

Memory 222 in the VSRP device 200 comprises volatile and/or non-volatile memory, and is configured to store executable instructions or code associated with an operating system (O/S) 224 and other applications, and one or more applications 226 (e.g., interactive programming guide (IPG), video-on-demand (VOD), personal video recording (PVR), WatchTV (associated with broadcast network TV), among other applications not shown such as pay-per-view, music, driver software, etc.).

Further included in one embodiment in memory 222 is video processing (VP) logic 228, which in one embodiment is configured in software. In some embodiments, VP logic 228 may be configured in hardware, or a combination of hardware and software. The VP logic 228, in cooperation with the processor 216, is responsible for interpreting auxiliary information and providing the appropriate settings for a display and output system 230 of the VSRP device 200. In some embodiments, functionality of the VP logic 228 may reside in another component within or external to memory 222 or be distributed among multiple components of the VSRP device 200 in some embodiments.

The VSRP device 200 is further configured with the display and output logic 230, as indicated above, which includes horizontal and vertical scalars 232, line buffers 231, and one or more output systems (e.g., configured as HDMI, DENC, or others well-known to those having ordinary skill in the art) 233 to process the decoded pictures and provide for presentation (e.g., display) on display device 140. FIG. 2B shows a block diagram of one embodiment of the display and output logic 230. It should be understood by one having ordinary skill in the art that the display and output logic 230 shown in FIG. 2B is merely illustrative, and should not be construed as implying any limitations upon the scope of the disclosure. For instance, in some embodiments, the display and output logic 230 may comprise a different arrangement of the illustrated components and/or additional components not shown, including additional memory, processors, switches, clock circuits, filters, and/or samplers, graphics pipeline, among other components as should be appreciated by one having ordinary skill in the art in the context of the present disclosure. Further, though shown conceptually in FIG. 2A as an entity separate from the media engine 206, in some embodiments, one or more of the functionality of the display and output logic 230 may be incorporated in the media engine 206 (e.g., on a single chip) or elsewhere in some embodiments. As explained above, the display and output logic 230 comprises in one embodiment the scalar 232 and one or more output systems 233 coupled to the scalar 232 and the display device 140. The scalar 232 comprises a display pipeline including a Horizontal Picture Scaling Circuit (HPSC) 240 configured to perform horizontal scaling, and a Vertical Scaling Picture Circuit (VPSC) 242 configured to perform vertical scaling. In one embodiment, the input of the VPSC 242 is coupled to internal memory corresponding to one or more line buffers 231, which are connected to the output of the HPSC 240. The line buffers 231 serve as temporary repository memory to effect scaling operations.

In one embodiment, under synchronized video timing and employment of internal FIFOs (not shown), reconstructed pictures may be read from the DPB and provided in raster scan order, fed through the scalar 232 to achieve the horizontal and/or vertical scaling instructed in one embodiment by the auxiliary information, and the scaled pictures are provided (e.g., in some embodiments through an intermediary such as a display buffer located in media memory 212) to the output port 233 according to the timing of a physical clock (e.g., in the clock circuit 218 or elsewhere) driving the output system 233. In some embodiments, vertical downscaling may be implemented by neglecting to read and display selected video picture lines in lieu of processing by the VPSC 242. In some embodiments, upon a change in the vertical resolution of the picture format, vertical downscaling may be implemented to all, for instance where integer decimation factors (e.g., 2:1) are employed, by processing respective sets of plural lines of each picture and converting them to a corresponding output line of the output picture. In some embodiments, non-integer decimation factors may be employed for vertical subsampling (e.g., using in one embodiment sample-rate converters that require the use of multiple line buffers in coordination with the physical output clock that drives the output system 233 to produce one or more output lines). Note that the picture resolution output via the output system 233 may differ from the native picture resolution (prior to encoding) or the implied spatial span (i.e., intended output picture resolution of a CVS that is signaled in the corresponding auxiliary information.

Referring once again to FIG. 2A, a communications port 234 (or ports) is (are) further included in the VSRP device 200 for receiving information from and transmitting information to other devices. For instance, the communication port 234 may feature USB (Universal Serial Bus), Ethernet, IEEE-1394, serial, and/or parallel ports, etc. The VSRP device 200 may also include one or more analog video input ports for receiving and/or transmitting analog video signals.

One having ordinary skill in the art should understand that the VSRP device 200 may include other components not shown, including decryptors, samplers, digitizers (e.g., analog-to-digital converters), multiplexers, conditional access processor and/or application software, driver software, Internet browser, among others. Further, though the VP logic 228 is illustrated as residing in memory 222, it should be understood that all or a portion of such logic 228 may be incorporated in, or distributed among, the media engine 206, the display and output system 230, or elsewhere. Similarly, in some embodiments, functionality for one or more of the components illustrated in, or described in association with, FIG. 2A may be combined with another component into a single integrated component or device.

As indicated above, the VSRP device 200 includes a communication interface 202 and tuner system 203 configured to receive an A/V program (e.g., on-demand or broadcast program) delivered as consecutive CVSes of a bitstream, wherein each CVS comprises of successive coded pictures and each CVS has a respectively corresponding auxiliary information that corresponds to the implied spatial span of the pictures in the CVS. The discussion of the following flow diagrams assumes a transition from a first to second CVS in a bitstream corresponding to, for instance, after a user- or system-prompted channel change event, resulting in the transmittal from the headend 110 and reception by the VSRP device 200 of the bitstream and auxiliary information pertaining to picture resolution, SAR and SSF, such auxiliary information respectively corresponding to each successive CVS of the bitstream. The VSRP device 200 starts decoding the bitstream at a RAP. The first picture of each CVS in the bistream corresponds to a RAP picture.

The auxiliary information corresponding to a CVS is provided prior to the to the first picture of the corresponding CVS. When the auxiliary information corresponding to a CVS introduces a change with respect to the prior CVS in picture resolution, SAR, or SSF, VSRP device 200 is able to determine the change prior to decoding the first picture of the CVS.

In addition, the auxiliary information may be also in the transport stream. Auxiliary information may reside in a packet header for which IPTV application software in the VSRP device 200 is configured to receive and process in some embodiments.

The VP system (e.g., encoder 111, splicer 112, decoding logic (e.g., media engine 206), and/or display and output logic 230) may be implemented in hardware, software, firmware, or a combination thereof. To the extent certain embodiments of the VP system or a portion thereof are implemented in software or firmware (e.g., including the VP logic 228), executable instructions for performing one or more tasks of the VP system are stored in memory or any other suitable computer readable medium and executed by a suitable instruction execution system. In the context of this document, a computer readable medium is an electronic, magnetic, optical, or other physical device or means that can contain or store a computer program for use by or in connection with a computer related system or method.

To the extent certain embodiments of the VP system or portions thereof are implemented in hardware, the VP system may be implemented with any or a combination of the following technologies, which are all well known in the art: a discrete logic circuit(s) having logic gates for implementing logic functions upon data signals, an application specific integrated circuit (ASIC) having appropriate combinational logic gates, programmable hardware such as a programmable gate array(s) (PGA), a field programmable gate array (FPGA), etc.

In general, recapping the above description, the auxiliary information is conveyed periodically. Further, some embodiments provide the auxiliary information in every channel. In some embodiments, the auxiliary information is only transmitted in a subset of the available channels, or the provision of the auxiliary information for a given channel or time frame is optional.

Having addressed certain embodiments of VP systems that decode the coded pictures of a bitstream, attention is directed to the use of the auxiliary information (or a separate and distinct piece of auxiliary information in some embodiments) to assist the processing of reconstructed video. An output clock (e.g., a clock residing in the clocking circuit 218 or elsewhere) residing in the VSRP device 200 drives the output of reconstructed pictures (e.g., with an output system 233 configured as HDMI or a DENC or other known output systems). The display and output logic 230 may operate in one of plural modes. In one mode, often referred to as passthrough mode, the VSRP device 200 behaves intelligently, providing an output picture format corresponding to the picture format determined upon the acquisition or start of a video service (such as upon a channel change) in union with the format capabilities of the display device 140 and user preferences. In a fixed mode (or also referred to herein as a non-passthrough mode), the output picture format is fixed by user input or automatically (e.g., without user input) based on what the display device 140 supports (e.g., based on interrogation by the set-top box of display device picture format capabilities). One problem that may arise in the absence of auxiliary information is that a change in picture format (e.g., between 1280×720 and 1920×1088) typically involves a tear-down (e.g., reconfiguration) of the physical output clock, thus introducing a disruption in the video presentation to the viewer. In addition, if inserted advertisements have a different picture format than implied spatial span (i.e., the intended picture format) of a television service, then the output stage may be switching several times, creating disruptions in television viewing, and possibly upsetting the subscriber's viewing experience.

In one embodiment, the splicer 112 and/or encoder 111 deliver auxiliary information for reception and processing by the display and output logic 230, the auxiliary information conveying to the display and output logic 230 that picture resolution of the intended output picture according to the implied spatial span, and the auxiliary information corresponding to each successive CVS further conveying to the display and output logic 230 an implied spatial span that remains constant. Auxiliary information conveys an implied spatial span to the VSRP device 200 so that the output pictures are implemented accordingly, upscaling or downscaling is implemented by the display and output logic 230 to achieve an output picture resolution that is constant. In other words, based on the auxiliary information, the display and output logic 230 is configured for proper scaling of the output of the decoded pictures.

In some embodiments a part of the auxiliary information may be provided according to a different mechanism or via a different channel or medium. For instance, the SSF may be provided via a different mechanism than the picture resolution and SAR, or via a different channel or medium.

As one example of an implementation using the auxiliary information to convey the output picture corresponding to the implied spatial span, consider a picture resolution of 1920×1080 as the main picture resolution of the video program and an alternate picture resolution corresponding to 1280×720. The auxiliary information may instruct the decoding logic to output the same implied spatial span for both decoded picture resolutions when each is received (e.g., the decoded alternate picture resolution upscaled to 1920×1080 and the decoded 1920×1080 pictures corresponding to the main picture resolution). In one embodiment, the 1280×720 coded pictures undergo decoding and are upscaled to be presented for display at 1920×1080. That is, in one embodiment, upon reception of the CVS containing successive 1280×720 coded pictures, the decoding logic processes the coded pictures to produce their respective decoded picture version and according to the auxiliary information and based on the 1280×720 picture resolution (e.g., which is part of the auxiliary information as signaled in the SPS), the display and output logic 230 accesses the decoded pictures from media memory 212 and upscales the decoded pictures to 1920×1080 (through the scalar 232 of the display pipeline) without tearing down the clock (e.g., pixel output clock) based on instructions from the auxiliary information.

The 1920×1088 compressed pictures, when received at the VSRP device 200, likewise are decoded and, for instance, the information provided in the SPS, and is processed by the display and output logic 230 for presentation also at 1920×1080 based on the auxiliary information. In other words, regardless of how the bitstream is decoded for a given video program, the scalar 232 and output system 233 are configured according to the picture resolution, SAR, and SSF provided by the auxiliary information to provide an implied spatial span that is constant for the corresponding output pictures.

Note that the benefits of certain embodiments of the VP systems disclosed herein are not limited to the client side of the subscriber television system 100. For instance, consider commercials and ad-insertion technology at the headend 110. In a cable network, national feeds are provided, such as FOX news, ESPN, etc. Local merchants may purchase times in these feeds to enable the insertion of local advertising. If FOX news channel is transmitted at 1280×720, and ESPN is transmitted at 1920×1088, one determination to consider in conventional systems is whether to provide the commercial in two formats, or select one while compromising the quality of the presentation in another. One benefit to the auxiliary information conveying the picture format or the main picture format corresponding to the associated bitstream as the intended picture output format is that commercials may be maintained (e.g., in association with the upstream splicer 112) in one picture format, as opposed to two picture formats.

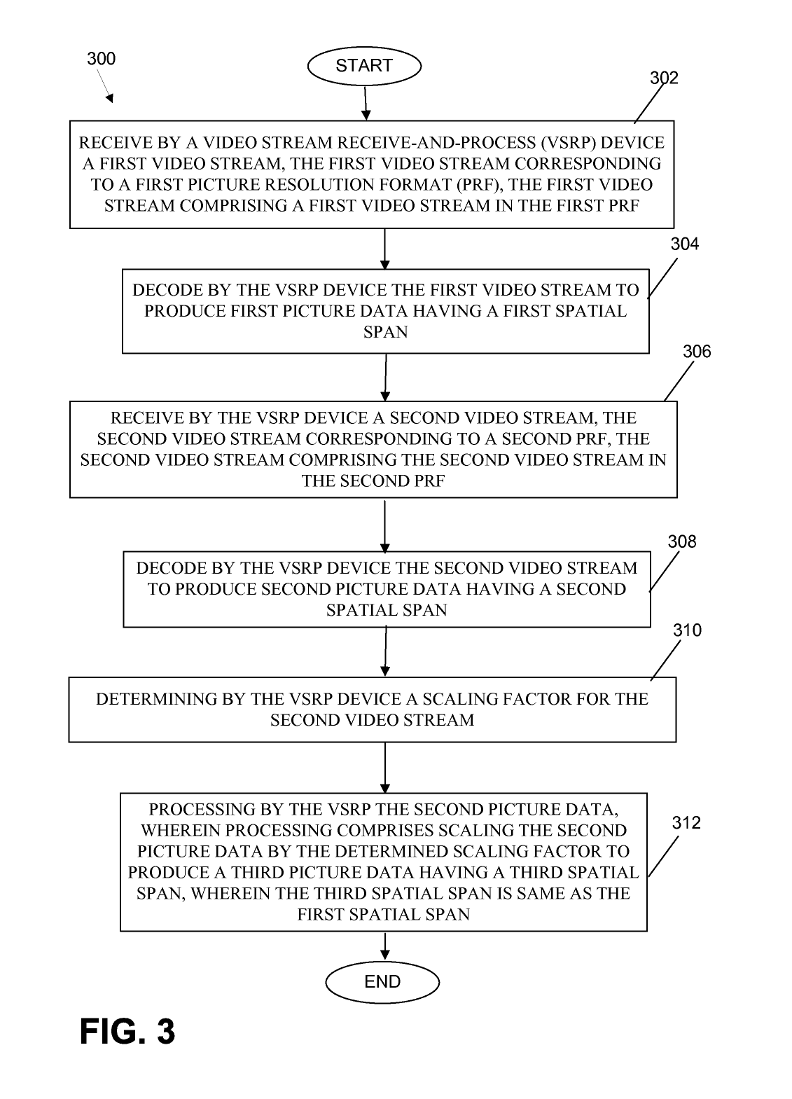

Having described various embodiments of VP system, it should be appreciated that one VP method embodiment 300, implemented at a VSRP device 200 and illustrated in FIG. 3, can be broadly described as receiving by a video stream receive-and-process (VSRP) device a first CVS, the first CVS corresponding to a first picture resolution (402); decoding by the VSRP device the first CVS to produce first picture data having a first spatial span (404); receiving by the VSRP device a second CVS, the second CVS corresponding to a second picture resolution (406); decoding by the VSRP device the second CVS to produce second picture data having a second spatial span (408); determining by the VSRP device a scaling factor for the second picture data decoded from the second CVS (410); and processing by the VSRP the second picture data, wherein processing comprises scaling the second picture data by a determined SSF to produce a third picture data having a third spatial span, wherein the third spatial span is same as the first spatial span (412).

In another embodiment, a video program, such as one corresponding to a television commercial, is inserted without changing its picture resolution when it has the same sample aspect ratio as the network feed's sample aspect ratio but irrespective of the picture resolution of the network feed, which may or may not be equal to the picture resolution of the commercial. If the picture resolution is different than the network feed and the sample aspect ratio are equal, the signaling of the sample aspect ratio is modified in the bitstream corresponding to the commercial to imply a different sample scale factor. The modification is performed in every SPS (sequence parameter set) instance in the bitstream (i.e., video stream) of the commercial or video program to be inserted. If the picture resolution and the sample aspect ratio are the same, no modification is required.

A splicer or commercial insertion device that performs digital program insertion (DPI), such as a video processing device operating as a commercial insertion device or DPI device in a cable television network or other subscriber television network, maintains and/or accesses a single copy the bitstream corresponding to a commercial to be inserted and replace a portion of the video program corresponding to a television service or broadcast service (e.g., ESPN). A video program includes at least one corresponding video stream and audio stream. Herein we refer to the video program of the service as the network feed.

The portion of the video stream of the network feed to be replaced is typically demarcated by corresponding signals that arrive a priori and indicate corresponding “out-points” and “in-points.” An out-point (or out-point) signals a location in the video stream (and corresponding audio stream) of video program to start the insertion of another video program, such as a television commercial. The in-point (or in-point) signals a location in the video stream (and corresponding audio stream) to return to the network feed's video program. An inserted video program would terminate immediately prior to the in-point and the network feed's video program is resumed thereafter.

All transitions from one to another video stream respectively corresponding to two video programs occur at the start of a CVS. The start of CVS is a RAP picture, such as an IDR picture or other intra coded picture. The start of a CVS has a respective sequence parameter set (SPS) that is different than the prior's CVS. Each SPS contains the sample aspect ratio information for the corresponding CVS. In an alternate embodiment, it contains also a corresponding sample scale factor for the corresponding CVS.

A server containing video programs corresponding to commercials is coupled to the DPI device. The DPI device accesses and inserts the video program corresponding to a commercial in a portion of the video program of a network feed, such portion as specified by corresponding outpoint and in-point signals.

When the CVSes corresponding respectively to the video program of a first commercial to be inserted and the video program of a first network feed have different picture resolutions but the same sample aspect ratio, such as when the respective sample aspect ratios of the two CVSes correspond to square samples, the SPS (or VUI of the SPS) in the CVS corresponding to the video program of the first commercial is changed to imply a different sample scale factor and maintain constant the 2D size and aspect ratio of the implied spatial span corresponding to the output pictures of successive CVSes. The first network feed is assumed to have the dominant picture resolution or be the main picture resolution. Every SPS instance corresponding to the first commercial is modified to imply the same aspect ratio but a different sample scale factor that yields the same two dimensional span in output pictures.

The first commercial is also inserted at a different time in a second network feed that has the same sample aspect ratio and same picture resolution as the first commercial. The implied sample scale factor of the first commercial is not modified. Thus, the one or more SPSes corresponding to the first commercial are not modified.

In a alternate embodiment, the first commercial is inserted contemporarily in the first network feed and the second network feed. The implied sample scale factor of the video program corresponding to the first commercial is not modified for insertion in the second network feed but the implied sample scale factor in every SPS of the video program corresponding to the first commercial is modified for insertion in the first network feed.

In one embodiment, the implied sample scale factor is signaled with a different aspect_ratio_idc value corresponding to the same sample aspect ratio but a different sample scale factor as described by the VUI syntax and Table 1 above, which corresponds to the semantics of the sample aspect ratio indicator that imply a SSF.

In another embodiment, the sample scale factor is signaled by aspect_ratio_idc value equal to Extended_SAR to provide in the SPS two explicit values corresponding to the sample width (sar_width) and the sample height (SAR_height) that provide the same sample aspect ratio as in the first network feed but a different sample scale factor than the sample scale factor in the first network feed. For instance, the sample aspect ratio of the first network feed may be square with a sample scale factor of 1 (i.e., aspect ratio idc=1 and the implied sample aspect ratio is 1:1), whereas the two values will both be equal but not equal to 1, such as when SAR_width=SAR_height=2.

In an alternate embodiment, the sample scale factor is signaled with the presence of the sample_scale_factor_flag in VUI parameters in the SPS and the corresponding sample_scale_factor_index that conveys a different sample scale factor in the table, as shown below by the VUI syntax and Sample Scale Factor table.

The sample_scale_factor_flag in VUI parameters signals the presence of a sample scale factor. The sample_scale_factor_flag is present when the aspect_ratio_info_present_flag=1, as shown below.

In view of the above description, it should be appreciated that other VP method and/or system embodiments are contemplated. For instance, one VP method embodiment may be implemented upstream of the VSRP device (e.g., at the headend 110). In such an embodiment, the encoder 111 or splicer 112 may implement the steps of providing a transport stream comprising a bitstream that includes a first picture format for a first CVS and a second picture format for a second CVS, the first picture format different than the second picture format, and including in the transport stream auxiliary information that conveys to a downstream device a fixed quantity of pictures allocated in a decoded picture buffer for processing the first sequence of pictures and the second sequence of pictures. Other embodiments are contemplated as well.

Any process descriptions or blocks in flow charts or flow diagrams should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art. In some embodiments, steps of a process identified in FIG. 3 using separate boxes can be combined. Further, the various steps in the flow diagrams illustrated in conjunction with the present disclosure are not limited to the architectures described above in association with the description for the flow diagram (as implemented in or by a particular module or logic) nor are the steps limited to the example embodiments described in the specification and associated with the figures of the present disclosure. In some embodiments, one or more steps may be added to the method described in FIG. 3, either in the beginning, end, and/or as intervening steps, and that in some embodiments, fewer steps may be implemented.

It should be emphasized that the above-described embodiments of the present disclosure are merely possible examples of implementations, merely set forth for a clear understanding of the principles of the VP systems and methods. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A method, comprising:
decoding by a video stream receive-and-process (VSRP) device a first video stream to produce a first picture data, the first video stream corresponding to a first picture resolution format (PRF), the first video stream comprising a first video service in the first PRF, the first picture data having a first spatial span;
decoding by the VSRP device a second video stream to produce a second picture data, the second video stream corresponding to a second PRF, the second video stream comprising a second video service in the second PRF, the second picture data having a second spatial span;
determining by the VSRP device a scaling factor for the second video stream; and
processing by the VSRP the second picture data, wherein processing comprises scaling the second picture data by the determined scaling factor to produce a third picture data having a third spatial span, wherein the third spatial span is same as the first spatial span.

2. The method of claim 1, wherein determining the scaling factor comprises:
receiving auxiliary information indicating a presence of a flag corresponding to the scaling factor; and
processing the auxiliary information to determine the scaling factor.

3. The method of claim 1, wherein determining the scaling factor comprises:
receiving auxiliary information indicating a presence of a flag corresponding to the scaling factor; and
processing the auxiliary information to determine a scaling factor index; and
performing a lookup operation in a scale factor table to determine the scaling factor corresponding to the scaling factor index.

4. The method of claim 1, wherein determining by the VSRP device the scaling factor for the second video stream comprises determining a vertical scaling factor and a horizontal scaling factor for the second picture data.

5. The method of claim 1, wherein determining by the VSRP device the scaling factor for the second video stream comprises determining the scaling factor which not equal to one.

6. The method of claim 1, wherein decoding by the VSRP device the first video stream to produce the first picture data having the first spatial span comprises decoding the first video stream to produce the first picture data having the first spatial span which is equal to the spatial span of a display device configured to display the decoded first picture data.

7. The method of claim 1, wherein decoding by the VSRP device the first video stream to produce the first picture data having the first spatial span comprises decoding the first video stream to produce the first picture data having the first spatial span which is equal to a standard spatial span of a display device configured to display the decoded first picture data.

8. The method of claim 1, wherein decoding by the VSRP device the first video stream to produce the first picture data having the first spatial span comprises decoding the first video stream to produce the first picture data having the first spatial span which is implied spatial span for the first video stream.

9. The method of claim 1, wherein decoding by the VSRP device the first video stream to produce the first picture data having the first spatial span comprises decoding the first video stream to produce the first picture data having a first aspect ratio, wherein decoding by the VSRP device the second video stream to produce the second picture data having the second spatial span comprises decoding the second video stream to produce the second picture data having a second aspect ratio, wherein the second aspect ratio is different from the first aspect ratio.

10. The method of claim 9, further comprising receiving auxiliary information having an aspect ratio flag, wherein the aspect ratio flag indicates presence of the scaling factor for the second picture data.

11. The method of claim 1, wherein determining by the VSRP device the scaling factor for the second video stream comprises determining the scaling factor by diving the second spatial span by the first spatial span.

12. A network device comprising a processor configured with logic to:
decode by a video stream receive-and-process (VSRP) device a first video stream to produce a first picture data, the first video stream corresponding to a first picture resolution format (PRF), the first video stream comprising a first video service in the first PRF, the first picture data having a first spatial span;
decode by the VSRP device a second video stream to produce a second picture data, the second video stream corresponding to a second PRF, the second video stream comprising a second video service in the second PRF, the second picture data having a second spatial span;
receive auxiliary information by the VSRP device;
process the received auxiliary information to determine a scaling factor for the second video stream; and
process by the VSRP the second picture data, wherein processing comprises scaling the second picture data by the determined scaling factor to produce a third picture data having a third spatial span, wherein the third spatial span is same as the first spatial span.

13. The network device of claim 11, wherein the processor is further configured with logic to receive the auxiliary information as video utility information (VUI).

14. The network device of claim 11, wherein the processor is further configured with logic to determine a vertical scaling factor and a horizontal scaling factor for the second picture data.

15. The network device of claim 11, wherein determining by the VSRP device the scaling factor for the second video stream comprises determining the scaling factor which is not equal to one.

16. The network device of claim 11, wherein receiving auxiliary information having an aspect ratio flag, wherein the aspect ratio flag indicates presence of the scaling factor for the second picture data.

17. The network device of claim 11, wherein the processor is further configured to receive an aspect ratio flag, wherein the aspect ratio flag indicates presence of the scaling factor for the second picture data.

18. A method, comprising:
receiving at a video stream receive-and-process (VSRP) device a video stream comprising a first portion of compressed pictures having a first picture format and a second portion having a second picture format during transmission over a given channel, wherein the first compressed picture of the second portion of compressed pictures is the first compressed picture in the video stream after the last compressed picture of the first portion of compressed pictures; and
decoding the first portion of the video stream to produce a first picture data having a first spatial span;
decoding the second portion of the video stream to produce a second picture data having a second spatial span;
receiving at the VSRP device auxiliary information corresponding to the video stream, the auxiliary information corresponding to indication of resizing the second spatial span;
determining a scaling factor;
post-processing by the VSRP the second picture data, wherein post-processing comprises scaling the second picture data by the determined scaling factor to produce a third picture data having a third spatial span, wherein the third spatial span is same as the first spatial span.

19. The method of claim 18, wherein receiving the auxiliary information by the VSRP device comprises receiving the auxiliary information as video utility information (VUI).

20. The method of claim 18, wherein determining by the VSRP device the scaling factor for the second video stream comprises determining a vertical scaling factor and a horizontal scaling factor for the second picture data.
